(19) United States
(12) Patent Application Publication
(10) Pub. No.: US 2016/0042639 A1
(43) Pub. Date: Feb. 11, 2016

(54) TRANSPORTATION PLAN CREATION SUPPORT APPARATUS AND TRANSPORTATION PLAN CREATION SUPPORT METHOD

(71) Applicant: TOYOTA JIDOSHA KABUSHIKI KAISHA, Toyota-shi, Aichi (JP)

(72) Inventors: Ryokichi ONISHI, Tokyo (JP); Keiko SHIMAZAKI, Tokyo (JP); Akira YOSHIOKA, Tokyo (JP); Takayuki KUSAJIMA, Tokyo (JP)

(21) Appl. No.: 14/442,210

(22) PCT Filed: Nov. 14, 2013
(86) PCT No.: PCT/JP2013/006703

§ 371 Date: May 12, 2015

(30) Foreign Application Priority Data
Dec. 12, 2012 (JP) 2012-271552

(51) Int. Cl. G08G 1/01; G08G 1/123

(52) U.S. Cl. CPC G08G 1/0125; G08G 1/123

(57) ABSTRACT

In order to obtain a traffic flow when a specific condition is given to a target transportation network, transportation condition data which is data representing time constraints of traveling by first transportation means whose operation is not scheduled, a transportation parameter which is a parameter related to an operation of second transportation means whose operation is scheduled, and a travel demand which is data representing the number of traveling users for each desired arrival time and destination are respectively acquired. In addition, a template for generating a mathematical model representing travel of users between nodes is stored. By applying the transportation condition data, the transportation parameter, and the travel demand to the template, a mathematical model representing travel of users between nodes is generated. A traffic flow is obtained by solving an optimization problem that is formulated by the mathematical model.

### TECHNICAL FIELD

The present invention relates to technology for creating an optimum transportation plan for a transportation network adopting multimodal transportation.

### BACKGROUND ART

In the field of transportation, there is an urgent need to address environmental issues. For example, by having users who have conventionally traveled by private cars switch to public transportation, a reduction in the impact on the environment can be achieved by reducing CO2 emission or the like.

Techniques for optimizing an operation schedule of trains or buses in order to make public transportation more convenient have been proposed. For example, Patent Literature 1 describes an operation system of transportation means which is capable of creating an operation plan that meets the preferences of users by collecting information regarding desired traveling routes and travel times from the users.

If all traveling users were to use public transportation, the impact on the environment can be minimized. However, since operations of public transportation are scheduled according to an operation diagram, simply optimizing an operation plan does not guarantee that a user is able to use public transportation whenever he or she desires. In addition, since cost accrued when traveling to a station or a bus stop is added, overall convenience of a user declines when only public transportation is used.

One way to address these problems is to combine private cars with public transportation in order to achieve a balance between reducing the impact on the environment and enhancing user convenience. Such a transportation mode which combines a plurality of transportation means is referred to as multimodal transportation.

### CITATION LIST

### Patent Literature

PTL 1: Japanese Patent Application Laid-open No. 2002-269671

### SUMMARY OF INVENTION

### Technical Problem

With multimodal transportation, there is a need to optimize transportation parameters. A transportation parameter is a parameter that can be adjusted by a transportation operator who manages transportation. Examples of a transportation parameter include operation intervals of a train that travels between stations and the number of buses bound for a station. By optimally adjusting such parameters, a mode of transportation which satisfies both users and transportation operators and which reduces the impact on the environment can be determined. However, adapting a technique for optimizing a transportation mode consisting of single transportation means such as that disclosed in Patent Literature 1 on multimodal transportation does not necessarily optimize overall traffic flow.

Conventionally, while proposals have been made for optimizing a transportation mode consisting of single transportation means such as described above, no proposals have been made for optimizing a traffic flow in multimodal transportation. As a result, obtaining optical transportation parameters had been difficult.

### Solution to Problem

The present invention has been made in consideration of the problem described above, and an object thereof is to provide a transportation plan creation support apparatus for obtaining an optimum transportation plan for a transportation network adopting multimodal transportation.

The present invention in its one aspect provides a transportation plan creation support apparatus for obtaining a traffic flow of users traveling from a point of origin to a destination in a transportation network which is made up of a plurality of nodes, first transportation means, and second transportation means, with the first transportation means the users being able to start travelling at any timing, and operation of the second transportation means being scheduled.

The first transportation means is transportation means which enables a user to depart at an arbitrary timing, and typical examples thereof include a private car and a bicycle. The first transportation means may also include foot traffic.

The second transportation means is transportation means whose operation is scheduled by a transportation operator, and typical examples thereof include a train, a fixed-route bus, a share-ride taxi, and the like.

The transportation plan creation support apparatus according to the present invention is an apparatus for obtaining a traffic flow of users in a transportation network in which the users can travel by combining first transportation means with second transportation means.

Specifically, the transportation plan creation support apparatus comprises a transportation condition acquiring unit configured to acquire transportation condition data which is data representing time constraints of travelling of the users between nodes using the first transportation means; a transportation parameter acquiring unit configured to acquire a transportation parameter which is a parameter associated with an operation of the second transportation means; a travel demand acquiring unit configured to acquire a travel demand which is data representing the number of users traveling the transportation network for each desired arrival time and destination; a model template storage unit configured to store a model template which is a template for generating a mathematical model representing travel of the users between nodes and which is a set of constraints of travelling of the users between nodes; a model generating unit configured to generate a mathematical model representing travel of the users between nodes by applying the transportation condition data, the transportation parameter, and the travel demand to the model template; and a data calculating unit configured to solve an optimization problem that is formulated by the generated mathematical model and obtaining a traffic flow that constitutes an optimum solution.

The transportation plan creation support apparatus according to the present invention is an apparatus for supporting the creation of a transportation plan for a transportation network constructed by connecting nodes with one another. More specifically, the transportation plan creation support apparatus according to the present invention is an apparatus which evaluates what kind of traffic flow is created when given transportation condition data, a transportation parameter, and a travel demand are supplied to a given transportation network.

Transportation condition data is data representing time constraints that apply when a user travels using the first transportation means and is, for example, a travel time between nodes. Other examples include a distance between nodes, an average travel speed, and an average travel time. In addition, values may vary depending on time slots. Furthermore, a transportation parameter is a parameter that can be adjusted by a transportation operator in the transportation network. Examples of a transportation parameter include an operation frequency and the number of operations of public transportation means and the like.

Travel demand is data representing the number of people desiring to travel from a point of origin to a destination for each desired arrival time. For example, a travel demand may be expressed by the number of people according to point of origin, destination, or desired arrival time. In addition, a travel demand can be generated based on previous traffic survey data, questionnaire results, and the like.

The number of users associated with a node that constitutes a transportation network can be expressed as a variable. In addition, a relationship among variables can be expressed using a mathematical model. For example, relationships such as “the number of people at station A is obtained by adding the number of people who have newly arrived at station A to the number of people present at station A to begin with and subtracting the number of people who have boarded trains at station A” and “everybody departing from node A arrives at node B after a predetermined period of time” can be expressed. Such relationships are referred to constraints. A collection of a plurality of constraints is referred to as a model template.

By adding the transportation condition data, the transportation parameter, and the travel demand described earlier to a model template, model generating unit is capable of generating a mathematical model representing travel of user under the constraints.

In addition, data calculating unit solves an optimization problem that is formulated by a generated mathematical model or, in other words, a mathematical planning problem.

Solving an optimization problem requires a condition of an optimum solution (hereinafter, an optimum solution condition). While any optimum solution condition can be used as long as the optimum solution condition can be expressed by a mathematical model, the optimum solution condition favorably represents a most rational action taken by users during travel such as “minimizing total travel time of all users”.

As described above, the transportation plan creation support apparatus according to the present invention is capable of obtaining an optimum solution or, in other words, capable of uniquely determining a variable that constitutes a mathematical model based on a model template, transportation condition data, a transportation parameter, a travel demand, and an optimum solution condition. Since an optimum solution is data representing an ideal traffic flow under a given condition, a transportation parameter can be evaluated by analyzing the optimum solution.

In addition, the transportation network may comprise at least two routes including a first route enabling a travel from a point of origin to a destination using only the first transportation means and a second route enabling a travel from the point of origin to the destination using at least the second transportation means, the model template stored in the model template storage unit may include constraints representing a relationship between a presence or absence of the second transportation means departing from a predetermined node on the second route at a predetermined time and the number of users departing from the predetermined node at the predetermined time, and the model generating unit may generate a mathematical model representing the number of users traveling by the second transportation means, using the constraints.

Since operations of the second transportation means are scheduled, departures cannot be made at arbitrary timings. In consideration thereof, the number of people departing from a given node on a second route at a given time is expressed using the presence/absence of the second transportation means departing from the node at the given time. For example, by assigning a value of 1 when a train departs at the given time and a value of 0 when a train does not depart at the given time and multiplying the values by riding capacity, the number of people starting travel from a station can be expressed. Providing such constraints enables users traveling by the second transportation means to be expressed by a mathematical model.

In addition, the model template stored in the model template storage unit may include a constraint representing a sum of the number of operations of the second transportation means which departs from a predetermined node on the second route within a predetermined time range, and the model generating unit may generate a mathematical model representing an operation of the second transportation means by using the constraint.

An operation schedule or operation intervals of the second transportation means can be expressed as a constraint in the form of “the number of operations of the second transportation means within a predetermined time range”.

In addition, the transportation parameter acquiring unit may acquire a plurality of transportation parameters, the model generating unit may generate a plurality of mathematical models by using the plurality of transportation parameters, and the data calculating unit may perform computations with respect to the plurality of mathematical models to obtain a plurality of traffic flows.

By performing a plurality of computations using a plurality of transportation parameters, a plurality of traffic flows can be acquired. Accordingly, a determination can be made as to which transportation parameter is most appropriate. For example, by preparing a plurality of patterns of the number of operations of trains and calculating CO2 emission and operation cost using the respective obtained traffic flows, the number of trains in service which achieve a balance between environmental impact and cost can be determined.

In addition, the data calculating unit may calculate an evaluation value for evaluating the transportation parameter from the obtained traffic flow and determines an optimum transportation parameter based on the evaluation value.

An evaluation value is a value for evaluating an inputted transportation parameter such as total CO2 emission, an operation cost of transportation means, an average travel time of users, and total waiting time of users. An evaluation value may be obtained by computing a plurality of evaluation values. The use of a plurality of evaluation values enables a transportation parameter to be scored and objectively evaluated.

In addition, favorably, the model template includes a constraint that all users arrive at a destination by a desired arrival time.

This is because it is meaningless to evaluate a transportation parameter that prevents users from arriving at a destination in time.

Furthermore, the transportation parameter acquired by the transportation parameter acquiring unit may be data representing an operation condition of public transportation means and may include at least any of the number of operations of the public transportation means, operation intervals of the public transportation means, and riding capacity of the public transportation means.

By including data representing the operation condition of public transportation means in a transportation parameter, an operation plan of the public transportation means can be evaluated. Data representing an operation condition of public transportation means may be data representing departure times at each node (a departure timetable) or the number of operations of the public transportation means during a predetermined time slot. In addition, the data may be a maximum operation interval or a minimum operation interval. Furthermore, by defining a riding capacity or, in other words, a maximum number of passengers that can be carried at one time, travel of users can be expressed more accurately. The operation condition data may be any data as long as the operation condition data is a parameter related to the operations of the public transportation means.

In addition, the data calculating unit may obtain a traffic flow under an optimum solution condition that a sum values obtained based on a ratio of an actual travel time to a minimum travel time of respective users takes a minimum value.

Assuming that a user takes a most rational action when traveling by transportation means, favorably, the optimum solution condition is set to a condition that minimizes a ratio of an actual travel time to a minimum travel time (in other words, a user does not waste time on a route).

Moreover, the present invention can be specified as a transportation plan creation support apparatus which includes at least a part of the units described above. The present invention can also be specified as a transportation plan creation support method and a transportation plan creation support program which include at least a part of the processes described above. The processes and the units described above can be freely combined and implemented as long as no technical contradictions arise.

### Advantageous Effects of Invention

According to the present invention, a transportation plan creation support apparatus for obtaining an optimum transportation plan for a transportation network adopting multimodal transportation can be provided.

Further features of the present invention will become apparent from the following description of exemplary embodiments with reference to the attached drawings.

### BRIEF DESCRIPTION OF DRAWINGS

FIG. 1 is diagram showing a relationship between nodes and links according to an embodiment;

FIG. 2 is a diagram showing a relationship between nodes and links expanded in a time axis direction;

FIG. 3 is a system configuration diagram of a transportation plan creation support apparatus according to an embodiment;

FIG. 4 is a diagram describing transportation condition data according to an embodiment;

FIG. 5 is a diagram describing operation condition data according to an embodiment;

FIG. 6 is a diagram describing travel demand data according to an embodiment;

FIG. 7 is a processing flow chart of a transportation plan creation support apparatus according to an embodiment; and

FIG. 8 is a graph representation of evaluation values calculated by a transportation plan creation support apparatus.

### DESCRIPTION OF EMBODIMENTS

### Embodiments

21 Outline of Transportation Parameter>

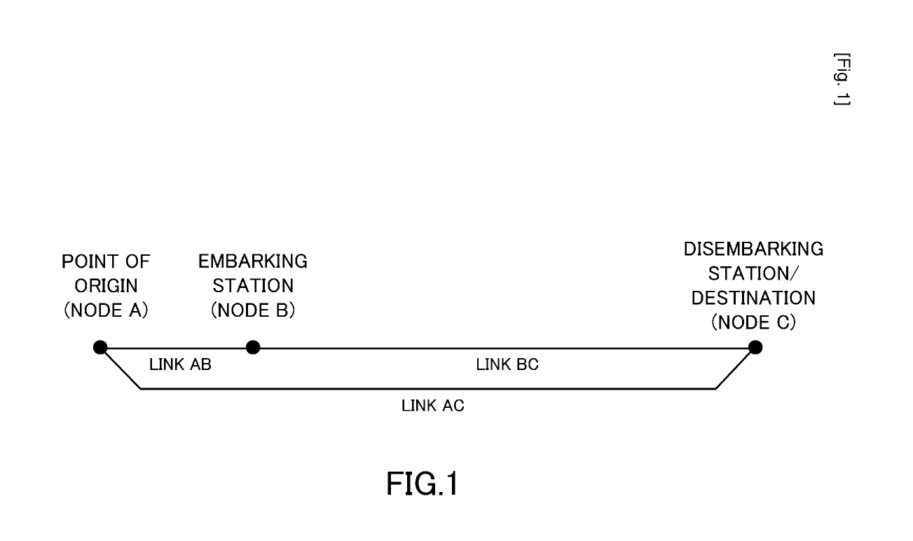

Before starting the description of the embodiments, transportation parameters will be described. FIG. 1 is a diagram showing an example of node arrangements and travel routes between the nodes. A node is a transportation hub. In the present embodiment, nodes include a point of origin, an embarking station, and a disembarking station (a destination). In the present embodiment, an example in which a person (hereinafter, a user) having departed from node A (for example, a home) that is a point of origin heads toward node C (for example, a workplace) that is a destination using arbitrary transportation means will be described with reference to the network shown in FIG. 1. Moreover, in the present embodiment, for the sake of simplicity, it is assumed that node C that is a disembarking station is the destination. Hereinafter, a route connecting nodes will be referred to as a link.

There are two routes from node A to node C. One is a route on which a user travels link AB by car, and transfers to a train at node B to head toward node C. Another is a route on which the user travels link AC by car. It is assumed that the user departs from the point of origin with the intention of arriving at the destination by a given predetermined time (for example, a starting time).

A transportation parameter that can be specified by a transportation operator who manages transportation means will now be described. A transportation parameter that can be specified in the illustrated network is operation conditions (for example, departure times and operation intervals) of trains servicing link BC.

A required travel time on links other than link BC is determined by factors such as traffic volume and cannot be specified by the transportation operator. Therefore, by setting operation conditions of trains servicing link BC, a mode of travel of the users (a traffic flow) is uniquely determined. The transportation plan creation support apparatus according to the present embodiment is an apparatus which obtains a traffic flow of an entire transportation network by computation when a transportation parameter is given. In addition, various costs of the entire network such as total CO2 emission, an operation cost of trains, and waiting time that occurs during travel can be calculated as evaluation values from the obtained traffic flow. Furthermore, the apparatus can obtain a plurality of traffic flows and calculate a plurality of evaluation values when a plurality of transportation parameters are given.

Details of a method of obtaining a traffic flow and data that can be acquired will be provided later.

<Outline of Travel Model>

A method by which the transportation plan creation support apparatus according to the embodiment determines a traffic flow will be described using the example shown in FIG. 1 or, more specifically, an example including nodes A, B, and C and two routes connecting the nodes A to C. Moreover, for the sake of simplicity, it is assumed that all users are to travel from a same point of origin to a same destination. In other words, all of the points of origin are node A and all of the destinations are node C.

In the present embodiment, a model representing travel of users (hereinafter, a travel model) is constructed and a traffic flow is calculated using the travel model. First, an outline of a travel model will be briefly described by way of example and, subsequently, an example of constructing a travel model for the transportation network shown in FIG. 1 will be described in detail.

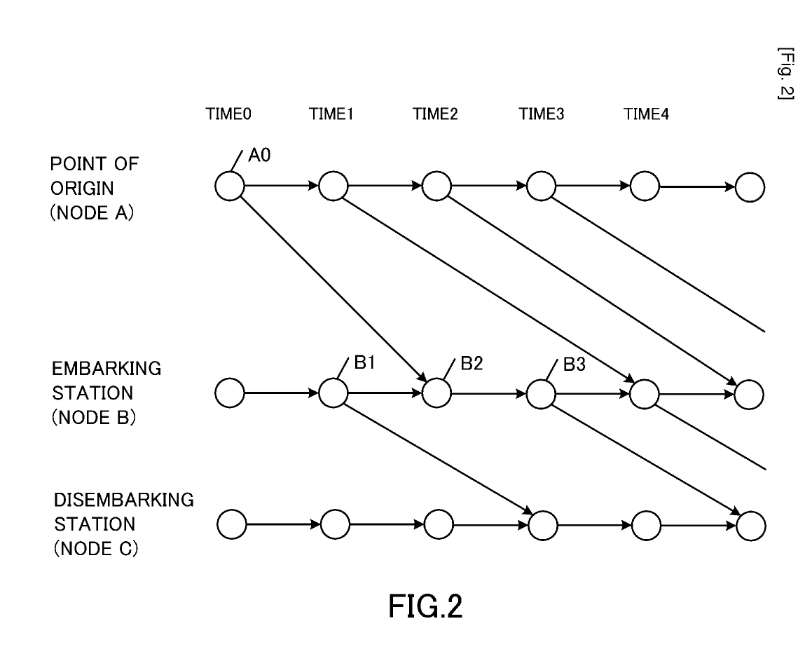

FIG. 2 is a diagram showing states of the nodes for each prescribed time in the network shown in FIG. 1. An abscissa represents a time axis. For example, when time 0 is 6:00, time 1 may be set to 6:01 and time 2 may be set to 6:02. Each divided time will be referred to as a time step. Although a pitch width of the time steps is set to 1 minute in the present example, any pitch width may be adopted.

In addition, arrows indicate directions in which the users can travel. For example, a user at node A at time 0 (A0) may depart toward node B or remain at node A. When traveling between nodes, a required travel time is to be added.

The number of users present at a node and the number of users entering or exiting a node at each time step can be expressed by variables. For example, the number of users present at node B at time 1 (B1) can be expressed as p_{(B,1)} and the number of users present at node B at time 2 (B2) can be expressed as p_{(B,2)}.

A relationship between variables can be expressed by a mathematical expression. For example, the number of people at B2 is obtained by subtracting the number of people who have boarded a train at node B at time 1 from the number of people at B1 and adding the number of people who have arrived at node B at time 2. In addition, when a train does not depart from node B at time 2, the number of people at B3 is the same as the number of people at B2.

As shown, the numbers of users associated with the respective nodes can all be expressed by mathematical expressions. In the present embodiment, a travel model is constructed using a mathematical expression.

<Details of Travel Model>

Next, an example of constructing a travel model for the transportation network shown in FIG. 1 will be described. The following seven variables are necessary for constructing a travel model.

(1) Home_{(t,n)}: the number of users who depart from node A at time t and desire to arrive at node C by time n

(2) CarToOffice_{(t,n)}: the number of users who depart from node A to node C by car at time t and desire to arrive at node C by time n

(3) CarToStation_{(t,n)}: the number of users who depart from node A to node B by car at time t and desire to arrive at node C by time n

(4) WaitAtStation_{(t,n)}: the number of users present at node B at time t and who desire to arrive at node C by time n

(5) LeaveStation_{(t,n)}: the number of users who depart from node B by train at time t and desire to arrive at node C by time n

(6) DeptStation₍ₜ₎: the number of users who depart from node B at time t

(7) ArriveStation₍ₜ₎: the presence/absence of a train arriving at node B at time t (0: absent, 1: present)

Moreover, in the present embodiment, the time step is set to 1 minute and ranges of times t and n are respectively set to 0 to 180 (minutes). For example, t=0 corresponds to 6:00 AM and t=180 corresponds to 9:00 AM.

The following 12 formulas can be defined by expressing users traveling on the transportation network shown in FIG. 1 using the seven variables described above. The 12 formulas below are conditions that are reliably satisfied (constraints according to the present invention) when obtaining a traffic flow. Each formula will now be described.

Expression 1 is a constraint regarding an occurrence of users at the point of origin (node A). Expression 1 represents the number of users who desire to arrive at the destination by time n. Now, let User(n) denote the number of users who desire to arrive at the destination by time n. For example, if there are 100 users who desire to arrive at the destination by time 90, then User(90)=100. While departure times of the 100 users from the point of origin are not yet determined, a total sum of users for all departure times (t=0 to 180) is 100. In other words, SHome_{(t,90)}=100. By giving User(n) to Expression 1, a plurality of mathematical expressions can be generated for each time taken by n.

$$\begin{matrix}[ Math . 1 ] & \\ {\sum }_{t = 0}^{180} {Home}_{( t , n )} = User ( n ) & ( Expression 1 )\end{matrix}$$

Expression 2 is a constraint regarding departure of users at the point of origin node. Specifically, Expression 2 shows that the number of people departing from node A is a sum of the number of people directly heading toward the destination (node C) by car and the number of people heading toward the departure station (node B) by car. Using Expression 2, a plurality of mathematical expressions can be generated for each combination of times taken by t and n.

[Math.2]

Home_{(t,n)}=CarToOffice_{(t,n)}+CarToStation_{(t,n)} (Expression 2)

Expression 3 is a constraint regarding the number of users at the departure station (node B). Now, let time s denote a departure time at node A which ensures arrival at node B by time t. Specifically, Expression 3 shows that the number of people at node B at time t+1 is obtained by adding the number of people having arrived at node B by time t and the number of people present at node B at time t and subtracting the number of people having departed from node B by train at time t. By giving a time s corresponding to time t to Expression 3, a plurality of mathematical expressions can be generated for each combination of times taken by t and n.

Moreover, when there is no departure time s at node A which ensures arrival at node B at time t, CarToStation=0 is established.

[Math.3]

WaitAtStation_{(t+1,n)}=CarToStation_{(s,n)}+WaitAtStation_{(t,n)}−LeaveStation_{(t,n)} (Expression 3)

Expression 4 is a constraint regarding the number of users at the destination (node C). Specifically, Expression 4 shows that the number of users arriving at the destination is a sum of the number of people heading toward node C from node B by train and the number of people heading toward node C from node A by car. Expression 4 represents the number of users who desire to arrive at the destination by time n or, in other words, User(n) described earlier. By giving User(n) to Expression 4, a plurality of mathematical expressions can be generated for each time taken by n.

$$\begin{matrix} [ Math . 4 ] & \\ {\sum }_{t = 0}^{180} {LeaveStation}_{( t , n )} + {\sum }_{t = 0}^{180} {CarToOffice}_{( t , n )} = User ( n ) & ( Expression 4 )\end{matrix}$$

Expression 5 is a constraint regarding the number of users departing from the departure station (node B). Since variable DeptStation is a sum of the people departing at time t and variable LeaveStation is the number of people at time t whose desired arrival time is time n, the relationship represented by Expression 5 is satisfied. Using Expression 5, a plurality of mathematical expressions can be generated for each time taken by t.

$$\begin{matrix}[ Math . 5 ] & \\ {\sum }_{n = 0}^{180} {LeaveStation}_{( t , n )} = {DeptStation}_{( t )} & ( Expression 5 )\end{matrix}$$

Expression 6 is a constraint regarding the departure of trains from the departure station (node B). Cp denotes a riding capacity per one formation of trains. In other words, Expression 6 shows that the number of people departing from the departure station (node B) at time t is equal to or smaller than the riding capacity per one formation of trains arriving at time t. By giving Cp to Expression 6, a plurality of mathematical expressions can be generated for each time taken by t.

[Math.6]

DeptStation₍ₜ₎<=Cp·ArriveTrain₍ₜ₎ (Expression 6)

Expression 7 is a constraint regarding the number of trains in service. Expression 7 represents a maximum number of trains in service which arrive at node B within a range of time t=0 to 180. The maximum number of trains in service is denoted by MaxTrain. By giving MaxTrain to Expression 7, a mathematical expression that represents the maximum number of trains in service can be generated.

$$\begin{matrix}[ Math . 7 ] & \\ {\sum }_{t = 0}^{180} {ArriveTrain}_{( t )} = MaxTrain & ( Expression 7 )\end{matrix}$$

Expressions 8 and 9 are constraints regarding operation intervals of trains.

Expression 8 defines a maximum operation interval of trains. k is a value representing a maximum operation interval of trains (a k step denotes a maximum time step during which a train does not arrive). In other words, Expression 8 shows that there are one or more trains arriving between an arbitrary time i and time i+k (where i ranges from 0 to 180−k). By giving k to Expression 8, a plurality of mathematical expressions in which a start time is set to i can be generated. Moreover, k can be varied according to the value of i. For example, k can be defined as a maximum interval of 10 minutes when t=0 to 90 and a maximum interval of 5 minutes when t>=91.

$$\begin{matrix}[ Math . 8 ] & \\ {\sum }_{t = i}^{i + k} {ArriveTrain}_{( t )} \geq 1 & ( Expression 8 )\end{matrix}$$

Expression 9 defines a minimum operation interval of trains. k is a value representing a minimum operation interval of trains (a k step denotes a minimum time step during which a train does not arrive). In other words, Expression 9 shows that the number of trains arriving between an arbitrary time i and time i+k is 1 or less. By giving k to Expression 9, a plurality of mathematical expressions in which a start time is set to i can be generated.

Moreover, k can be varied according to the value of i in a similar manner to Expression 8. For example, k can be defined as a minimum interval of 5 minutes when t=0 to 90 and a minimum interval of 3 minutes when t>=91.

$$\begin{matrix}[ Math . 9 ] & \\ {\sum }_{t = i}^{i + k} {ArriveTrain}_{( t )} \leq 1 & ( Expression 9 )\end{matrix}$$

Expressions 10 to 13 are constraints regarding the desired arrival time. In other words, Expressions 10 to 13 are constraints for eliminating people who are unable to arrive at the destination by the desired arrival time.

Expression 10 is a constraint for eliminating people who head towards node C from node A by car but are unable to arrive at the destination by the desired arrival time. Here, let time s (where time s may take a plurality of values) denote a departure time at node A which prevents arrival at node C by time n when heading toward node C by car. In other words, Expression 10 defines that there is no one departing from node A at time s and heading toward node C by car among people desiring to arrive at node C by time n. By giving a time s corresponding to time n to Expression 10, a plurality of mathematical expressions can be generated for each combination of times taken by s and n.

[Math.10]

CarToOffice_{(s,n)}=0 (Expression 10)

Expression 11 is a constraint for eliminating people who are unable to arrive at the destination by the desired arrival time from people embarking on a train at node B. Now, let time s denote a departure time at node B which prevents arrival at node C by time n. In other words, Expression 11 defines that there is no one departing from node B at time s and heading toward node C by train among people desiring to arrive at node C by time n. By giving a time s corresponding to time n to Expression 11, a plurality of mathematical expressions can be generated for each combination of times taken by s and n.

[Math.11]

LeaveStation_{(s,n)}=0 (Expression 11)

Expression 12 is a constraint for eliminating people who head towards node B from node A by car but are unable to arrive at the destination by the desired arrival time. Now, let time s denote a departure time at node A which prevents arrival at node C by time n even when transferring to a train at node B and the transfer requires no waiting time. In other words, Expression 12 defines that there is no one departing from node A at time s and heading toward node B to transfer to a train among people desiring to arrive at node C by time n. By giving a time s corresponding to time n to Expression 12, a plurality of mathematical expressions can be generated for each combination of times taken by s and n.

[Math.12]

CarToStation_{(s,n)}=0 (Expression 12)

Expression 13 is a constraint for eliminating people who are unable to arrive at the destination by the desired arrival time from people waiting at node B. Now, let time s denote a time which prevents arrival at node C by time n when present at node B at the time. In other words, Expression 13 defines that there is no one waiting for a train at node B at time s among people desiring to arrive at node C by time n. By giving a time s corresponding to time n to Expression 13, a plurality of mathematical expressions can be generated for each combination of times taken by s and n.

[Math.13]

WaitAtStation_{(s,n)}=0 (Expression 13)

While 12 types of constraints have been exemplified above, arbitrary constraints can be added if necessary. An arbitrary constraint may be any constraint as long as the constraint can be represented by a mathematical expression. For example, if there is a parking lot adjacent to the station at node B, a constraint that the sum of people arriving at node B by car is equal to or less than a capacity of the parking lot may be added.

A group of expressions obtained by expanding all of the Expressions 1 to 13 constitutes a travel model according to the present invention.

However, since Expressions 1 to 13 simply represent conditions that must be fulfilled for travel, a travel model cannot be generated unless specific values are added.

A more specific description will now be given. Although mathematical expressions can be individually expanded from the constraints represented by Expressions 2 and 5, mathematical expressions cannot be expanded for the other constraints unless the six types of information below are available.

(1) Required travel time between nodes A and B (necessary for giving time s corresponding to time t to Expression 3)

(2) Time at nodes A and B which prevents arrival by a desired arrival time (necessary for giving time s corresponding to time n to Expressions 10 to 13)

(3) Number of users desiring to arrive at destination by time n (necessary for giving time User(n) to Expressions 1 and 4)

(4) Maximum number of trains in service (necessary for giving MaxTrain to Expression 7)

(5) Maximum operation interval and minimum operation interval of trains (necessary for giving time step k to Expressions 8 and 9)

(6) Riding capacity of trains (necessary for giving Cp to Expression 6)

Information representing (1) to (6) above will now be described.

Once a required travel time of each link is known, (1) and (2) above can be obtained. Information representing a required travel time of each link will be referred to as a “transportation condition”. In addition, information representing (3) above will be referred to as a “travel demand”. Furthermore, information representing (4) to (6) above will be referred to as an “operation condition”.

The transportation plan creation support apparatus according to the present embodiment generates a travel model (a plurality of mathematical expressions) necessary for computation by storing information defining the constraints represented by Expressions 1 to 13 (hereinafter, a mathematical expression template) and applying the “travel demand”, the “transportation condition”, and the “operation condition” described above.

Moreover, the operation condition described above corresponds to a transportation parameter according to the present invention and the transportation condition corresponds to transportation condition data according to the present invention. In addition, the mathematical expression template described above corresponds to a model template according to the present invention.

<Obtaining Optimum Solution>

Since a travel model is a set of equalities or inequalities, a travel model can be solved as an optimization problem by giving an optimum solution condition. As a result, since the seven variables described earlier can be specified for all times, a traffic flow for a target transportation network can be obtained.

An optimum solution condition maximizes or minimizes an objective function. An optimum traffic flow occurs when all users travel with least waste. Therefore, in the present embodiment, an objective function is set as represented by Expression 14 and a solution that minimizes the objective function is obtained. In Expression 14, idealTravelTime denotes a shortest travel time. In other words, a solution which minimizes a total sum of a p-th power of a ratio of an actual travel time to the shortest travel time for all users is obtained.

p denotes an exponent. When p is 1, a total sum of delay with respect to the shortest travel time is minimized. However, even if a total sum of overall delay is minimized, it is possible that a user with significantly low convenience is locally created. In consideration thereof, by increasing p, so-called “outliers” can be eliminated and a delay rate can be averaged. For example, p can be selected from a range of 1 to 8. When p is made infinite, the delay rates of all users become equal.

$$\begin{matrix}[ Math . 14 ] & \\ {\sum }_{t , n} {{Home}_{( t , n )} ( \frac{n - t}{idealTravelTime} )}^{p} & ( Expression 14 )\end{matrix}$$

By solving an optimization problem constituted by the plurality of mathematical expressions described earlier with mathematical planning, the transportation plan creation support apparatus according to the embodiment can obtain an optimum traffic flow when a “travel demand”, a “transportation condition”, and an “operation condition” are given to an arbitrary network.

In addition, by obtaining a plurality of solutions while varying the conditions described above, a transportation parameter that produces a most ideal evaluation value can be obtained. Furthermore, by computing a plurality of evaluation values, problems such as a tradeoff between operation cost and convenience can also be accommodated.

The second transportation means according to the present invention is transportation means which allows departures only at prescribed times. However, according to the present embodiment, the number of users traveling on the second transportation means can be expressed using Expression 6. In addition, an operation of the second transportation means can be expressed using Expressions 7 to 9.

<System Configuration>

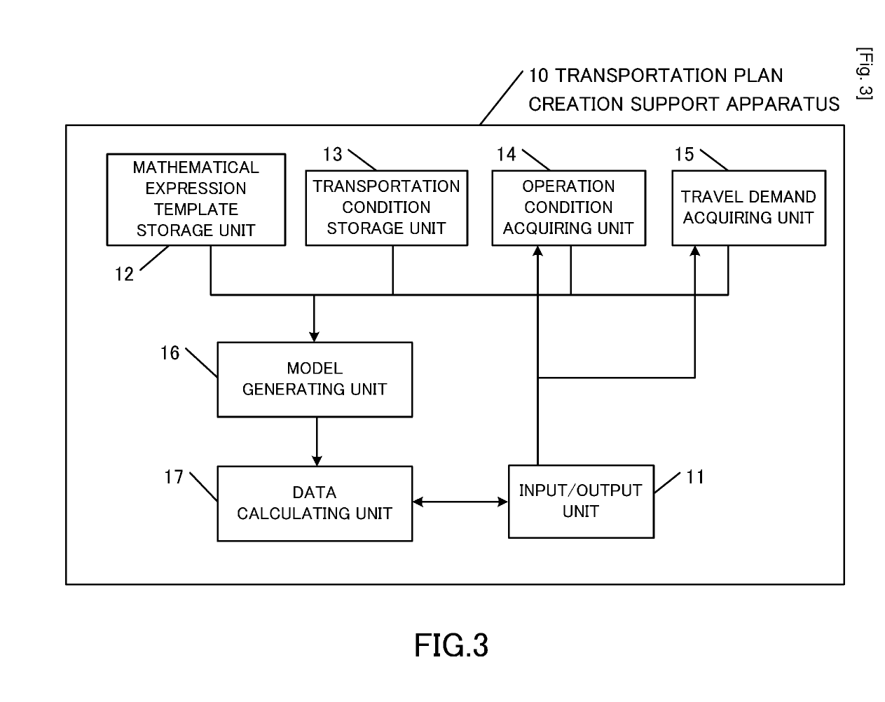

A description of a system configuration of the transportation plan creation support apparatus which performs the operations described above will now be given with reference to FIG. 3. A transportation plan creation support apparatus 10 according to the embodiment is a computer which stores a mathematical expression template and transportation conditions and which obtains a traffic flow satisfying an optimum solution condition when a travel demand and an operation condition of a given time slot are inputted.

The transportation plan creation support apparatus 10 includes a CPU, a main storage device, and an auxiliary storage device. When a program stored in the auxiliary storage device is loaded onto the main storage device and executed by the CPU, the respective means shown in FIG. 3 are activated (the CPU, the main storage device, and the auxiliary storage device are not shown). Moreover, the transportation plan creation support apparatus 10 may be a combination of a plurality of computers.

An input/output unit 11 is a unit for acquiring an operation condition and a travel demand necessary for computation from a user and presenting an obtained evaluation value to the user. In addition, the input/output unit 11 is a unit for acquiring a mathematical expression for computing an evaluation value from a user. The input/output unit 11 is constituted by a liquid crystal display, a keyboard, a touch panel, and the like.

A mathematical expression template storage unit 12 is a unit for storing a mathematical expression template for generating a travel model. A travel model can be constructed by applying a travel demand, a transportation condition, and an operation condition to a mathematical expression template. A mathematical expression template is unique to a target transportation network and is created and stored in advance.

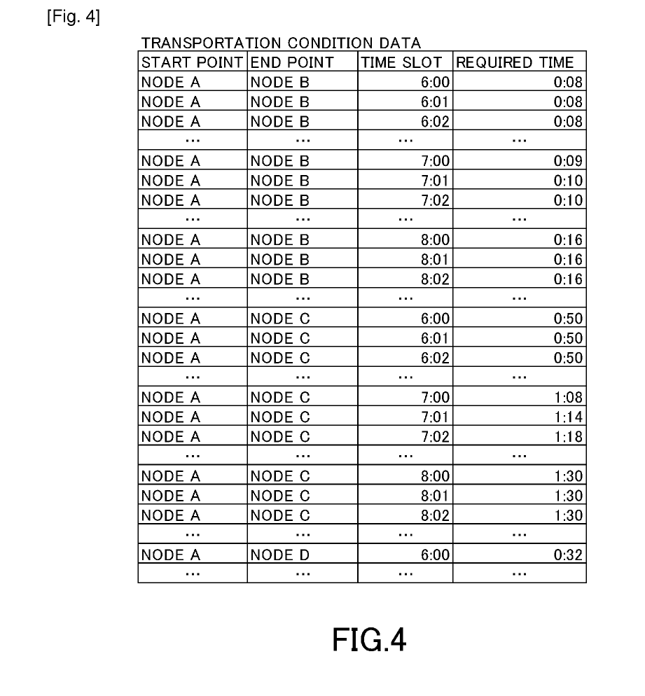

A transportation condition storage unit 13 is a unit for storing data representing a transportation condition (transportation condition data). FIG. 4 shows an example of transportation condition data. In this case, a required travel time from node A to node B by car, a required travel time from node A to node C by car, and a required travel time from node B to node C by train are stored for each departure time. Transportation condition data is also unique to a target transportation network and is created and stored in advance.

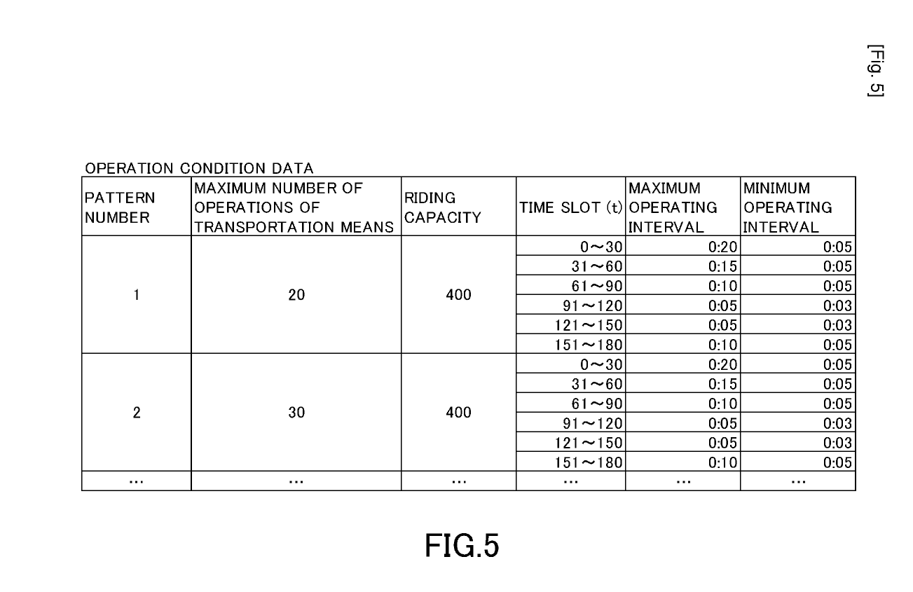

An operation condition acquiring unit 14 is a unit for acquiring data representing an operation condition of public transportation means (operation condition data) from the input/output unit 11. Operation condition data is data which defines a maximum number of operations of the public transportation means and a riding capacity of the public transportation means for each pattern and which further defines a maximum operation interval and a minimum operation interval of the public transportation means for each time slot. FIG. 5 shows an example of operation condition data. In this case, respective operation conditions are defined for pattern 1 and pattern 2.

Moreover, the operation condition acquiring unit 14 may acquire operation condition data from the input/output unit 11 every time a computation is performed or may store data inputted from the input/output unit 11 and use the data in a next or a subsequent computation.

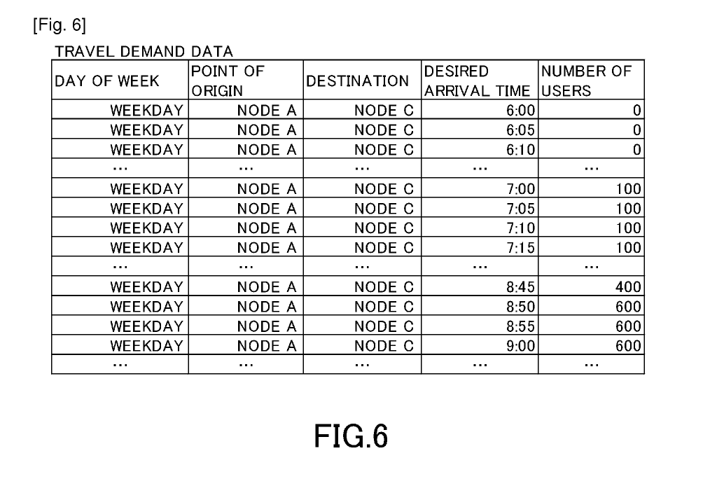

A travel demand acquiring unit 15 is a unit for acquiring data representing a travel demand (travel demand data) from the input/output unit 11. Travel demand data is data that defines the number of people for each point of origin, destination, and desired arrival time. FIG. 6 shows an example of travel demand data. While the point of origin is fixed to node A and the destination is fixed to node C in the present embodiment, when a plurality of points of origin and destinations can be defined, the point of origin and the destination may be set freely.

Moreover, the travel demand acquiring unit 15 may acquire travel demand data from the input/output unit 11 every time a computation is performed or may store data inputted from the input/output unit 11 and use the data in a next or a subsequent computation.

A model generating unit 16 is a unit for generating a travel model according to the present invention. By applying the transportation condition data stored in the transportation condition storage unit 13, the operation condition data acquired by the operation condition acquiring unit 14, and the travel demand data acquired by the travel demand acquiring unit 15 to the mathematical expression template stored in the mathematical expression template storage unit 12, a group of mathematical expressions that represents travel of users or, in other words, a travel model can be generated.

A data calculating unit 17 is a unit for solving an optimization problem by mathematical planning using the travel model generated by the model generating unit 16 as input. The data calculating unit 17 may use any method as long the data calculating unit 17 is a solver (an optimization solver) capable of solving a mathematical planning problem. The objective function represented by Expression 14 and an optimum solution condition that the optimum solution minimizes the objective function are stored in advance in the data calculating unit 17.

In addition, the data calculating unit 17 can store a formula for calculating an evaluation value. The formula is acquired from the input/output unit 11.

<Processing Flow Chart>

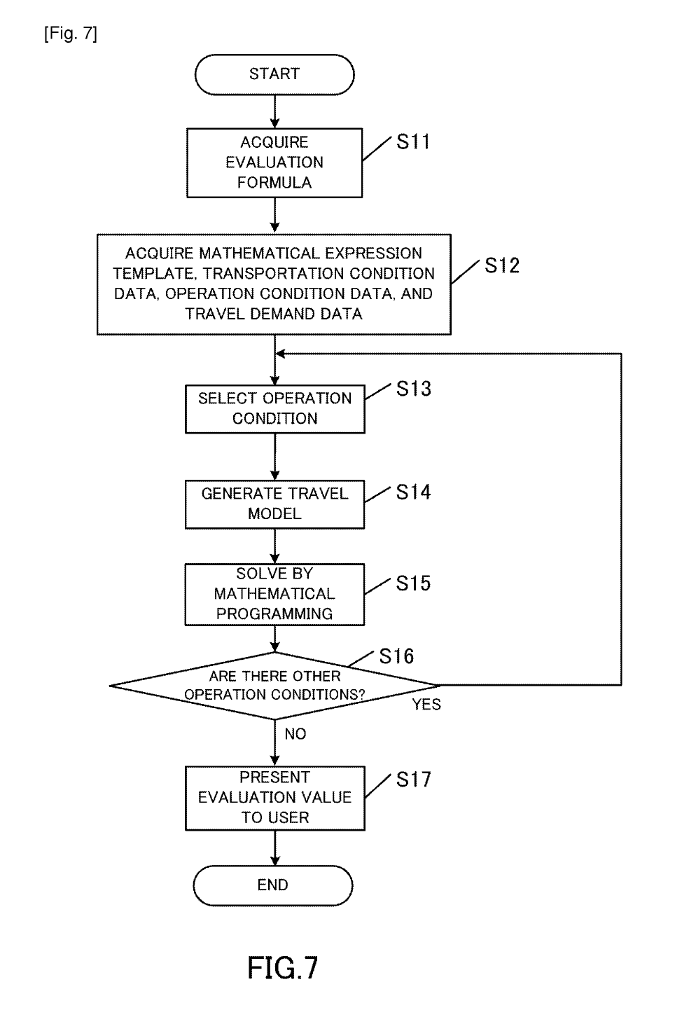

Next, a method of calculating a traffic flow carried out by the transportation plan creation support apparatus according to the present embodiment will be described in detail with reference to FIG. 7.

First, in step S11, the data calculating unit 17 acquires a formula for calculating an evaluation value (hereinafter, an evaluation formula) from the input/output unit 11 and temporarily stores the evaluation formula. While any evaluation value may be used such as total CO2 emission, average travel time, and maximum travel time as long as the evaluation value can be expressed by variables constituting the travel model, total CO2 emission will be used here.

Total CO2 emission can be obtained by multiplying the number of people heading toward node C from node A by car by a coefficient, adding a product of the number of people heading toward node B from node A by car multiplied by a coefficient, and adding a product of the number of trains in service multiplied by a coefficient.

For example, when CO2 emission of a single car that travels between nodes A and C is 2.34 kg, CO2 emission of a single car that travels between nodes A and B is 0.47 kg, CO2 emission of one formation of trains that travels between nodes B and C is 17.64 kg, since total CO2 emission is represented by Expression 15, Expression 15 may be inputted as the evaluation formula.

$$\begin{matrix} [ Math . 15 ] & \\ {\sum }_{t , n} {CarToOffice}_{( t , n )} \cdot 2.34 + {\sum }_{t , n} {CarToStation}_{( t , n )} \cdot 0.47 + {\sum }_{t} {ArriveTrain}_{( t )} \cdot 17.64 & ( Expression 15 )\end{matrix}$$

In step S12, the model generating unit 16 respectively acquires a mathematical expression template, transportation condition data, operation condition data, and travel demand data from the mathematical expression template storage unit 12, the transportation condition storage unit 13, the operation condition acquiring unit 14, and the travel demand acquiring unit 15.

In step S13, the model generating unit 16 selects one operation condition from the acquired operation condition data. In the case of the example shown in FIG. 5, the operation condition to which pattern number 1 is assigned is selected. Subsequently, in step S14, the transportation condition data and travel demand data acquired in step S12 and the operation condition selected in step S13 are applied to the mathematical expression template acquired in step S12 to generate a plurality of mathematical expressions. The generated mathematical expressions are temporarily stored by the model generating unit 16.

Next, in step S15, the group of mathematical expressions stored by the model generating unit 16 is transmitted to the data calculating unit 17, and the data calculating unit 17 solves an optimization problem that is formulated by the group of mathematical expressions and an optimization condition using mathematical planning. As described above, the data calculating unit 17 is a solver capable of solving a mathematical planning problem and obtaining an optimum solution for all defined variables. Let us assume that the optimization condition used in this case minimizes the objective function represented by Expression 14.

Subsequently, using the formula acquired in step S11, an evaluation value to be presented to a user is computed and is presented to the user via the input/output unit 11. For example, total CO2 emission is presented.

In step S16, a check is performed to see whether there is an unprocessed operation condition other than the operation condition selected in step S13, and if so, a return is made to step S13 to select the unprocessed operation condition. By repeating this procedure, an evaluation value is calculated for each defined operation condition pattern and presented to the user.

At this point, an operation condition pattern that produces a best evaluation value may be extracted and presented. For example, when total CO2 emission is set as the evaluation value, an operation condition pattern that produces a lowest evaluation value may be presented.

### Advantageous Effect of Invention

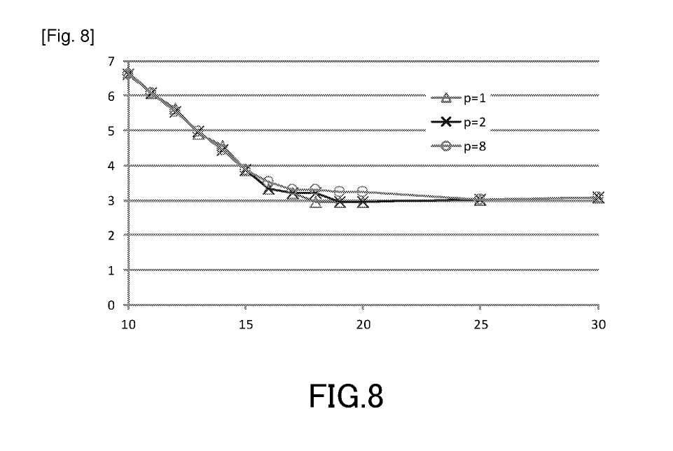

A result of performing a plurality of computations while varying the maximum number of trains in service and calculating a variation in total CO2 emission will now be described. FIG. 8 is a diagram which plots “the maximum number of trains in service per three hours” on an abscissa and “total CO2 emission (t)” on an ordinate and which shows a computation result for each exponent p. FIG. 8 shows that by varying the maximum number of trains in service per three hours within a range of 10 to 30 trains, while the impact on the environment is improved rapidly up to around 16 trains in service, the improvement is gradually blunted or, in other words, an investment effect is no longer apparent as the maximum number of trains in service equals or exceeds 16. In addition, FIG. 8 shows that the more p is increased in order to suppress a worst value of delay, the more difficult it becomes to lower total CO2 emission.

According to the result shown in FIG. 8, for example, setting the number of trains in service per three hours to around 16 to 17 enables total CO2 emission to be reduced efficiently. Obviously, instead of calculating only total CO2 emission, other evaluation values may be calculated at the same time. For example, by simultaneously calculating an average travel time of users, the number of trains in service which achieves a balance between environmental impact and convenience can be determined.

As described above, the transportation plan creation support apparatus according to the embodiment is capable of obtaining a flow of people (traffic flow) under given conditions by expressing the number of people associated with a node by a variable and describing a relationship between variables by a mathematical expression. In addition, the transportation plan creation support apparatus according to the embodiment is capable of computing an evaluation value for evaluating a transportation parameter from the obtained traffic flow.

Furthermore, by defining a plurality of operation condition patterns of public transportation means, an evaluation value for each operation condition can be acquired. Accordingly, an optimum transportation parameter that could not have been discovered by conventional methods can be determined.

### Modifications

The embodiment described above simply represents an example and various modifications may be made to the present invention without departing from the spirit and scope thereof.

For example, while a simple example in which all users follow a same route has been shown in the description of the embodiment, traffic in which users head toward a plurality of destinations from a plurality of points of origin can also be accommodated. In this case, the exemplified mathematical expression template may be defined for each route of the users and a travel demand may be defined for each route.

In addition, cases which combine three or more transportation means can also be accommodated. When changing network topology of the transportation network, the mathematical expression template stored in the mathematical expression template storage unit 12 and the transportation condition data stored in the transportation condition storage unit 13 may be modified so as to conform to the target transportation network.

Furthermore, while an example in which patterns of operation conditions of public transportation means are classified and an optimum pattern is determined has been shown in the description of the embodiment, parameters other than operation conditions can also be evaluated as long as the parameters can be adjusted by the transportation operator. For example, a node representing a parking lot may be defined and a parking capacity may be set as a parameter or a node representing an intersection may be defined and the number of vehicles that can pass in a unit time can be set as a parameter. When evaluating a parameter other than an operation condition, a corresponding mathematical expression may be defined as a constraint and a plurality of computations may be performed while varying patterns.

Moreover, while a condition that minimizes Expression 14 has been set as an optimum solution condition in the description of the embodiment, an arbitrary condition can be used as the optimum solution condition. For example, an objective function representing a sum of a physical burden incurred by users due to travel may be created and computations may be performed so as to obtain a minimum value of the objective function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-271552, filed on Dec. 12, 2012, which is hereby incorporated by reference herein in its entirety.

### REFERENCE SIGNS LIST

10: Transportation plan creation support apparatus

11: Input/output unit

12: Mathematical expression template storage unit

13: Transportation condition storage unit

14: Operation condition acquiring unit

15: Travel demand acquiring unit

16: Model generating unit

17: Data calculating unit

1. A transportation plan creation support apparatus for obtaining a traffic flow of users traveling from a point of origin to a destination in a transportation network which is made up of a plurality of nodes, first transportation means, and second transportation means, with the first transportation means the users being able to start travelling at any timing, and operation of the second transportation means being scheduled,
the transportation plan creation support apparatus comprising:
a transportation condition acquiring unit configured to acquire transportation condition data which is data representing time constraints regarding travelling of the users between nodes using the first transportation means;
a transportation parameter acquiring unit configured to acquire a transportation parameter which is a parameter associated with an operation of the second transportation means;
a travel demand acquiring unit configured to acquire a travel demand which is data representing the number of users traveling the transportation network for each desired arrival time and destination;
a model template storage unit configured to store a model template which is a template for generating a mathematical model representing travel of the users between nodes and which is a set of constraints regarding travelling of the users between nodes;
a model generating unit configured to generate a mathematical model representing travel of the users between nodes by applying the transportation condition data, the transportation parameter, and the travel demand to the model template; and
a data calculating unit configured to solve an optimization problem that is formulated by the generated mathematical model and obtaining a traffic flow that constitutes an optimum solution.

2. The transportation plan creation support apparatus according to claim 1, wherein
the transportation network comprises at least two routes including a first route enabling a travel from a point of origin to a destination using only the first transportation means and a second route enabling a travel from the point of origin to the destination using at least the second transportation means,
the model template stored in the model template storage unit includes constraints representing a relationship between a presence or absence of the second transportation means departing from a predetermined node on the second route at a predetermined time and the number of users departing from the predetermined node at the predetermined time, and
the model generating unit generates a mathematical model representing the number of users traveling by the second transportation means, using the constraints.

3. The transportation plan creation support apparatus according to claim 2, wherein
the model template stored in the model template storage unit includes a constraint representing a sum of the number of operations of the second transportation means which departs from a predetermined node on the second route within a predetermined time range, and
the model generating unit generates a mathematical model representing an operation of the second transportation means by using the constraint.

4. The transportation plan creation support apparatus according to claim 1, wherein
the transportation parameter acquiring unit acquires a plurality of transportation parameters,
the model generating unit generates a plurality of mathematical models by using the plurality of transportation parameters, and
the data calculating unit performs computations with respect to the plurality of mathematical models to obtain a plurality of traffic flows.

5. The transportation plan creation support apparatus according to claim 4, wherein
the data calculating unit calculates an evaluation value for evaluating the transportation parameter from the obtained traffic flow and determines an optimum transportation parameter based on the evaluation value.

6. The transportation plan creation support apparatus according to claim 1, wherein
the model template includes a constraint that all users arrive at a destination by a desired arrival time.

7. The transportation plan creation support apparatus according to claim 1, wherein
the transportation parameter acquired by the transportation parameter acquiring unit is data representing an operation condition of public transportation means and includes at least any of the number of operations in the public transportation means, operation intervals of the public transportation means, and riding capacity of the public transportation means.

8. The transportation plan creation support apparatus according to claim 1, wherein
the data calculating unit obtains a traffic flow under an optimum solution condition that a sum values obtained based on a ratio of an actual travel time to a minimum travel time of respective users takes a minimum value.

9. A transportation plan creation support method of obtaining a traffic flow of users traveling from a point of origin to a destination in a transportation network which is made up of a plurality of nodes, first transportation means, and second transportation means, with the first transportation means the users being able to start travelling at any timing, and operation of the second transportation means being scheduled, wherein
a computer implements:
a step of acquiring transportation condition data which is data representing time constraints regarding travelling of the users between nodes by using the first transportation means;
a step of acquiring a transportation parameter which is a parameter associated with an operation of the second transportation means;
a step of acquiring a travel demand which is data representing the number of users traveling the transportation network for each desired arrival time and destination;
a step of acquiring a model template which is a template for generating a mathematical model representing travel of users between nodes and which is a set of constraints regarding travelling of the users between nodes;
a step of generating a mathematical model representing travel of users between nodes by applying the transportation condition data, the transportation parameter, and the travel demand to the model template; and
a step of solving an optimization problem that is formulated by the generated mathematical model and obtaining a traffic flow that constitutes an optimum solution.

10. A non transitory computer readable storing medium recording a transportation plan creation support program for obtaining a traffic flow of users traveling from a point of origin to a destination in a transportation network which is made up of a plurality of nodes, first transportation means, and second transportation means, with the first transportation means the users being able to start travelling at any timing, and operation of the second transportation means being scheduled, wherein
the transportation plan creation support program causes a computer to implement:
a step of acquiring transportation condition data which is data representing time constraints regarding travelling of the users between nodes by using the first transportation means;
a step of acquiring a transportation parameter which is a parameter associated with an operation of the second transportation means;
a step of acquiring a travel demand which is data representing the number of users traveling the transportation network for each desired arrival time and destination;
a step of acquiring a model template which is a template for generating a mathematical model representing travel of users between nodes and which is a set of constraints regarding travelling of the users between nodes;
a step of generating a mathematical model representing travel of users between nodes by applying the transportation condition data, the transportation parameter, and the travel demand to the model template; and
a step of solving an optimization problem that is formulated by the generated mathematical model and obtaining a traffic flow that constitutes an optimum solution.
